(19) United States
(12) Patent Application Publication
(10) Pub. No.: US 2021/0245529 A1
(43) Pub. Date: Aug. 12, 2021

(54) HEATING ROLLER FOR INK-BASED IMAGE FORMING APPARATUS

(71) Applicant: HEWLETT-PACKARD DEVELOPMENT COMPANY, L.P., Spring, TX (US)

(72) Inventors: Heungsup PARK, Suwon-si (KR); Juntae KIM, Suwon-si (KR); Brett BUCHHOLTZ, Vancouver, WA (US); Lonny MORGAN, Vancouver, WA (US); Dongwoo LEE, Suwon-si (KR); Richard Lee BRINKLY, Vancouver, WA (US); Kevin LO, Vancouver, WA (US); Youngsu LEE, Suwon-si (KR); Kihyuk LEE, Suwon-si (KR)

(21) Appl. No.: 16/973,017

(22) PCT Filed: Oct. 12, 2018
(86) PCT No.: PCT/US2018/055640

§ 371 Date: Dec. 7, 2020

(51) Int. Cl. B41J 11/00; B41F 23/04; B41M 7/00; B41J 13/076

(52) U.S. Cl. CPC B41J 11/00242; B41J 13/076; B41M 7/009; B41F 23/042

(57) ABSTRACT

A heating roller for a wet ink-based image forming apparatus includes a roller having a contact surface to contact a print medium having wet ink deposited thereon by wet ink-based image forming apparatus. The heating roller conductively heats the print medium and dries and flattens the print medium. The heating roller includes a heating element embedded along the roller. The heating element rotates with the roller as the roller rotates. The heating element generates and conducts heat to the contact surface so as to conductively heat the print medium through the contact surface when the contact surface contacts the print medium.

### BACKGROUND

A wet ink-based image forming apparatus, such as an ink-jet printer, produces an image on a print medium by ejecting ink droplets onto the print medium. The ink-based image forming apparatus include an ink-based image former, such as an ink-jet nozzles, to form an image onto the print medium based on image data input to the ink-base image forming apparatus. The ink-based image forming apparatus may form images at various printing speeds and in different printing qualities, depending on the configurations of the ink-based image forming apparatus.

When the ink-based image forming apparatus deposits ink onto the print medium, drying ink deposited on the print medium and/or the print medium wetted by ink deposited may be a part of the printing process.

### BRIEF DESCRIPTION OF THE DRAWINGS

FIG. 1 illustrates an example of an ink-based image forming apparatus.

FIG. 2 illustrates an example of the print medium dryer.

FIG. 3 illustrates an example of the heat conduction-based drying configuration.

FIG. 4 illustrates an example of the pressing roller.

FIG. 5 illustrates an example cross-sectional view of the pressing roller.

FIG. 6 illustrates a cross-sectional view of the structure of the heating roller according to an example.

FIG. 7 illustrates a layer structure of the heating roller according to an example.

FIG. 8 illustrates an example of the heating medium (heating element) and the exterior layer.

FIG. 9 illustrates an example of a power connection.

FIG. 10 illustrates an example of a non-contact drying configuration.

FIG. 11 illustrates a block diagram of a control configuration according to an example.

### DETAIL DESCRIPTION

In this disclosure, known functions or constructions are not described in detail since they would obscure the disclosure with unnecessary detail. Moreover, when the specification states that one constituent element is “connected to” another constituent element, it includes a case in which the two constituent elements are ‘connected to each other with another constituent element intervened therebetween’ as well as a case in which the two constituent elements are ‘directly connected to each other.’ Further, when one constituent element “comprises” or “includes” another constituent element, unless specifically stated to the contrary, it refers to that another constituent elements may be further included rather than precluding the same. Further, the expression “image forming apparatus” as used herein includes an apparatus that prints printing data generated at a terminal such as a computer onto a print medium. Examples of the image forming apparatus may include a copy machine, a printer, a facsimile, or a multi-function printer (MFP) implementing a combination of functions of the copy machine, printer, or facsimile. The printer, the scanner, the fax machine, the multi-function printer (MFP), a display apparatus or the like may represent any apparatus that can perform the image forming job. As used herein, the term “and/or” includes any and all combinations of one or more of the associated listed items. Expressions such as “at least one of,” when preceding a list of elements, modify the entire list of elements and do not modify the individual elements of the list.

When an wet ink-based image forming apparatus forms an image on a print medium using the ink-based image former for the image forming apparatus, the print medium may be wet by ink sprayed from the ink-based image former, and a surface of the print medium may be unevenly deformed during this process, which affects the quality of the printed print medium. Moreover, when the print media are discharged and stacked, a height of the print media may be increased due to a deformed surface of the print media. The delay between the printing and the drying also affects the final print image quality.

A wet ink-based image forming apparatus may be implemented with a heating roll to dry a print medium or ink deposited onto the print medium. The heating roll may include a roll having a center space and a built-in heater or heat source disposed inside the roll in the center space, such as a halogen lamp. When the heat source is connected to a non-rotating power connector, the heat source is fixed to the power connector to be non-rotatable, and as result, is spaced apart from a rotatable portion of the roll to avoid a contact between the non-rotating heat source and the rotating roll. Because of the space between the heat source and the inner surface of the roll, heat is transferred by heat radiation and/or convection, and a loss in heat occurs during the heat transfer process. In other words, the space between the heat source and the inner surface of the roll results in a heat loss and an additional power consumption of the heat source. As a result, more time to heat up the heating roll is added to compensate the heat loss and/or a rate of heat transfer by radiation and/or convection. Such heating time after the initiating the printing operation and until the printed image is produced can affect the efficiency of operating an image forming apparatus, as well as a user's experience with operating the image forming apparatus.

Transferring heat by heat conduction, for example, by adding a heating element as a heating medium contacting the roll can reduce or at least partially remove the space between the heating medium and a surface of the roll. A heating roller having a heating medium placed between an inner surface and an outer surface of the roller, for example, without a space in between the heating medium and the surface of the heating roller, may transfer heat by heat conduction more efficiently in a shorter time period compared to the roll having the heat source transferring heat to the roll by heat radiation or heat convection. Reducing or at least partially removing the space between the heating source and the surface of the roll, for example, by not having the heating source in the center space, may allow the roll itself to be designed with more rigid materials without considering its potential heat insulation or retardant effect combined with the space between the inner surface of the roller and the heat source. Accordingly, such a heating roller implemented with a heating medium may have more rigid structure, and as a result, the heating roller with the heating medium may be able to apply higher pressing force and may have a simultaneous flattening effect while drying a print medium and/or ink deposited onto the print medium.

Although examples discussed below are directed to drying or flattening wet ink printed media such as inkjet printed media, the illustrated drying system may be incorporated into any liquid ink based printing system or method where a drying or flattening mechanism is implemented.

The description and drawings merely illustrate examples of the disclosure. Therefore, various arrangements may be devised that, although not explicitly described or shown herein, are encompassed by the disclosure.

A variety of different ink based printing mechanisms, such as inkjet printing mechanisms, may employ the system described herein, such as printers, copiers, plotters, cameras, facsimile or multi-function hardcopy devices, as well as auxiliary devices for use in conjunction with such printing mechanisms, but for convenience, an ink-based image forming apparatus is illustrated and described.

According to an example, an ink-based image forming apparatus may include a variety of devices or components for forming and processing the ink-based image, or provided so that such a variety of devices or components may be disposed to be subsequently coupleable or connectable to the manufactured ink-based image forming apparatus.

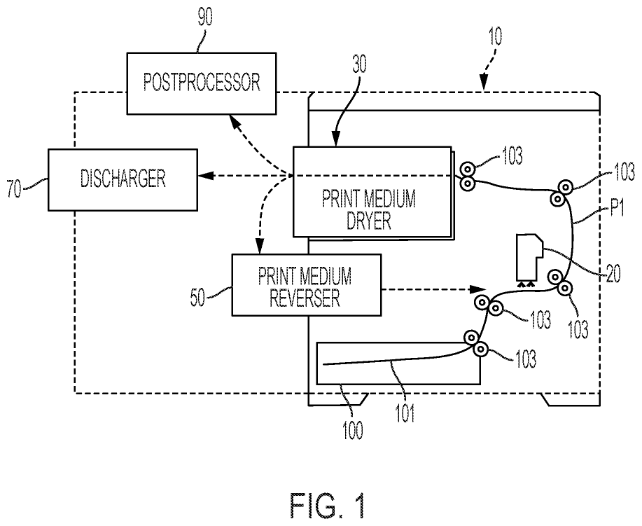

FIG. 1 illustrates an example of a wet ink-based image forming apparatus 10. Referring to FIG. 1, an ink-based image forming apparatus 10 may include a print medium feeder 100 to supply a print medium 101 to be transferred along the transfer path P1. The ink-based image forming apparatus 10 may include an ink-based image former 20 to selectively deposit ink on a side of a print medium 101 conveyed to the ink-based image former 20. The backside of print medium 101 opposite to the side being deposited with the ink may either be a blank surface or a surface that has been deposited with ink. Moreover, after the ink-based image former 20 forms the ink-based image on the print medium 101, the print medium 101 in which an image is formed onto by the ink-based image former 20, may be transported to a print medium reverser 50, reversed by the print medium reverser 50 and transferred back to the ink-based image former 20, such that the ink-based image former 20 can form another image on the opposite side of the print medium 101 opposite to the side having the formed image. The ink-based image forming apparatus 10 may include a print medium dryer 30 to dry the print medium 101 in which the image is formed onto by the ink-based image former 20. After the print medium dryer dries the print medium 101, the print medium 101 may be transported to the discharger 70 to be removed from the ink-based image forming apparatus 10, or may be transported to a variety of processing components or devices. For example, the print medium 101 may be transported to the post-processor (finisher) 90 for further processing the print medium 101, or transported to the print medium reverser to be reversed and redirected to the ink-based image former 20 such that the ink-based image former can form another image on the opposite side of the print medium 101. According to an example, the post-processor 90 may perform an operation such as arranging loaded print medium 101 and stapling the print medium 101. According to an example, a variety of components or devices including the ink-based image former 20, the print medium dryer 30, the print medium reverser 50, the discharger 70, and/or the post-processor 90 may be included in the ink-based image forming apparatus, or provided so that such a variety of components or devices including the ink-based image former 20, the print medium dryer 30, the print medium reverser 50, the discharger 70, and/or the post-processor 90 may be provided to be subsequently coupleable or connectable to the manufactured ink-based image forming apparatus based on contexts of how the manufactured ink-based image forming apparatus is to be used. For example, the post-processor 90 may be provided separately from the ink-based image forming apparatus 10, and can be connected to the ink-based image forming apparatus 10 to perform post-processing functions.

The ink-based image former 20 may include a variety of different suitable ink application systems, such as ink-jet based system, which may include a thermal inkjet printing system which involves use of heat for achieving ejection of ink. According to another example, the ink-based image former 20 may include a charge controlled printing system in which electrostatic attraction is used for ejecting ink. As another example, the ink-based image former 20 may include an inkjet printing system that can use vibration pressure generated by a piezoelectric element for ejecting ink. For example, the ink-based image former 20 may adopt an acoustic technique for ejection of ink. In the acoustic technique, an electric signal is transformed into an acoustic beam and the compositions are irradiated by the acoustic beam so as to be ejected by radiation pressure.

According an example, a variety of different suitable ink application systems as the ink-based image former 20 may include ink application systems employing those that are stationary during printing and span to form an image forming zone, referred to as page-wide-array print bars or reciprocating printheads, which, for diagrammatic purposes, may also be illustrated by the ink-based image former 20.

According to an example, the ink-based image former 20 may be implemented using one or any combination of the above mentioned examples of different suitable ink application systems.

According to an example, a variety of print medium transport mechanism may be implemented to move a print medium 101 along its transfer path P1 connecting the print medium feeder 100, the ink-based image former 20 and other components or devices involved in the process of forming an image by the ink-based image forming apparatus 10, such as the ink-based image former 20, the print medium dryer 30, the print medium reverser 50, the discharger 70. Such a print medium transport mechanism may include drive roller systems or belt transport systems with or without a vacuum hold-down assist. For example, an ink-based image forming apparatus 10 may include a transfer roller 103. According to an example, a print medium 101 is loadable in the print medium feeder 100, which is insertable into the ink-based image forming apparatus 10, and the loaded print medium 101 is transferrable towards the ink-based image former 20 by the transfer roller 103 for image formation by the ink-based image former 20.

According to an example, an ink-based image forming apparatus 10 may include the print medium dryer 30 to dry a print medium 101 having an image formed onto the print medium by the ink-based image former 20. For example, the print medium dryer 30 can dry the print medium 101 by drying ink deposited onto the print medium 101. According to an example, the print medium dryer 30 may dry the print medium 101 based on a parameter including, for example, an amount of the wet ink deposited onto the print medium, a type of the wet ink, a type of the print medium, or any combination thereof. The print medium dryer 30 may be disposed along a conveying path of the print medium 101 connecting the ink-based image former 20, in a transfer direction of the print medium 101 through the transfer path P1 to be transferred to and out of the ink-based image former 20, to receive the print medium 101 having an image formed thereon by the ink-based image former 20. According to an example, there may be a variety of ways to implement the print medium dryer 30 in the ink-based image forming apparatus 10. For example, the print medium dryer 30 may be disposed in the ink-based image forming apparatus 10. For example, the print medium dryer 30 may be disposed to be coupleable to the ink-based image forming apparatus 10 externally or internally.

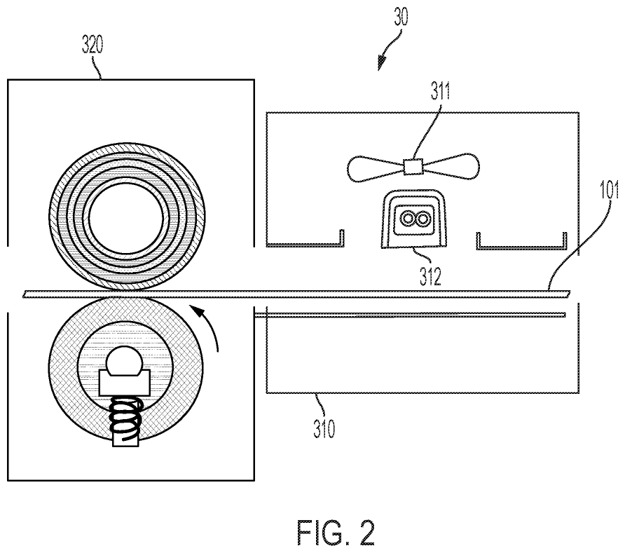

FIG. 2 illustrates an example of the print medium dryer 30. Referring to FIG. 2, the print medium dryer 30 may include a heat conduction-based drying configuration 320 to dry the print medium 101 by heat conduction. The heat conduction-based drying configuration 320 according to an example may dry the print medium 101 by contacting the print medium 101 and transferring heat to the print medium 101 by heat conduction. The heat conduction-based drying configuration 320 according to an example may dry the print medium 101 based on a parameter including, for example, an amount of the wet ink deposited onto the print medium, a type of the wet ink, a type of the print medium, or any combination thereof. The print medium dryer 30 may also include a non-contact drying configuration 310. The non-contact drying configuration 310 may dry the print medium 101 by air circulation, heat radiation, heat convection, or any combination thereof. The non-contact drying configuration 310 according to an example may dry the print medium 101 based on a parameter including, for example, an amount of the wet ink deposited onto the print medium, a type of the wet ink, a type of the print medium, or any combination thereof.

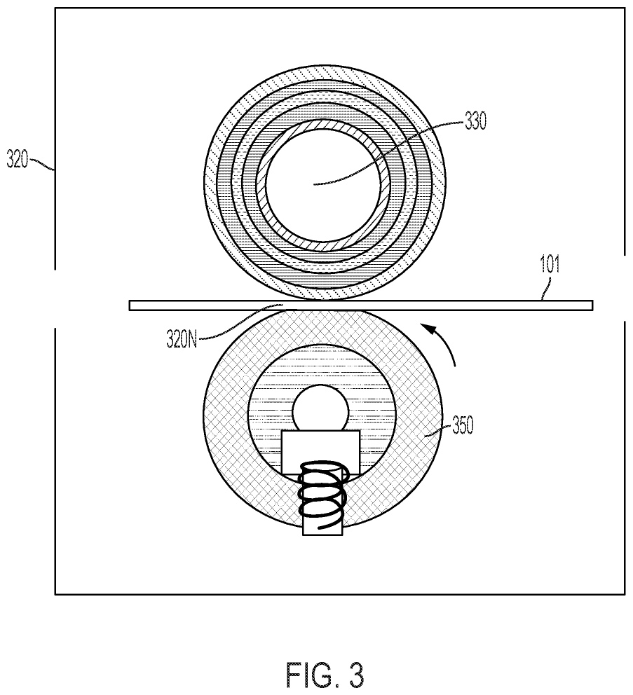

FIG. 3 illustrates an example of the heat conduction-based drying configuration 320. Referring to FIG. 3, the heat conduction-based drying configuration 320 may include a heating roller 330 to dry the print medium 101 having ink deposited thereon. The heating roller 330 may flatten the print medium 101. For example, the heating roller 330 can simultaneously dry and flatten the print medium 101. According to an example, the heating roller may dry and/or flatten the print medium 101 based on a parameter including, for example, an amount of the wet ink deposited onto the print medium, a type of the wet ink, a type of the print medium, or any combination thereof.

The heat conduction-based drying configuration 320 may be implemented in a variety of configurations. For example, the heat conduction-based drying configuration 320 may include one or a plurality of heating rollers 330, with or without another roller in combination, to dry the print medium 101 by conducting heat. For example, the heat conduction-based drying configuration 320 may also include a pressing roller 350. The print medium 101 may be wet by an ink sprayed from the ink-based image former 20, and a surface of the print medium 101 may be unevenly deformed during this process. Therefore, the unevenly deformed surface of the print medium 101 may be evenly flattened by passing between the heating roller 330 and the pressing roller 350. According to an example, the pressing roller 350 may be disposed next to the heating roller 330, to press a portion of an exterior surface of the heating roller 330 so as to form a nip 320N, and so as to contact and press the print medium 101 toward the heating roller 330 when the print medium 101 passes between the nip 320N formed by the heating roller 330 and the pressing roller 350. Accordingly, a print medium 101 passing through the nip 320N is dried by heat transferred from the heating roller 330. Moreover, the print medium 101 passing through the nip 320N can also be simultaneously flattened by the heat and the pressure applied by the heating roller 330 and the pressing roller 350. According to an example, a suitable amount of the pressure may be applied to facilitate the drying process, the flattening of the print medium 101 or to simultaneously dry and flatten the print medium 101. For example, a suitable amount of the pressure may be applied to facilitate the drying process based on a parameter including, for example, an amount of the wet ink deposited onto the print medium, a type of the wet ink, a type of the print medium, or any combination thereof. For example, pressure in the nip 320N may be adjusted to increase drying efficiency, a flattening effect, or both simultaneously. For example, the suitable amount of the pressing force may be from about 10 kilogram-force (unit: kg f) to about 20 kg f. According to an example, the heating roller and pressing roller have rigidity sufficient to apply the pressing force to apply the pressure. According to an example, the combined heat and pressure in the nip 320N over a larger area may promote more efficient drying while substantially improving flattening effects. According to an example, the combined heat and pressure in the nip 320N may be adjusted based on a parameter including, for example, an amount of the wet ink deposited onto the print medium, a type of the wet ink, a type of the print medium, or any combination thereof.

The pressing roller 350 may press toward the heating roller 330 and apply a pressing force toward the heating roller 330, or may be pressed by the heating roller 330, such that a pressing force is applied inbetween the heating roller 330 and the pressing roller 350. The print medium 101 may be simultaneously dried and flattened by the heat applied by the heating roller 330 and by being pressed by the pressing force applied between the heating roller 330 and the pressing roller 350. For example, after the ink-based image former 20 forms an image on the print medium 101, the print medium 101 with the formed image is first placed in the print medium dryer 30 and travels along a conveying path of the transfer path P1 through a nip 320N formed between the heating roller 330 and the pressing roller 350. The print medium 101 having ink deposited thereon may travel through the nip 320N with a printed side against or facing the heating roller 330 and its reverse or non-printed side against or facing the pressing roller 350 so that the contact and heat from the heating roller 330 will dry the ink. The printed side of the print medium 101 does not necessarily need to contact the heating roller 330. Also, the print medium 101 may have any orientation that allows the heating roller 330 to dry the ink. For example, the print medium 101 having ink deposited thereon may travel through the nip 320N with its printed side against or facing the pressing roller 350 and its reverse or non-printed side against or facing the heating roller 330 so that the contact and heat from the heating roller 330 will dry the ink. According to an example, the pressing roller 350 may be replaced with another heating roller 330 such that opposite sides of the print medium 101 are against or face the two heating rollers 330. For example, the heat conduction-based drying configuration 320 may incorporate two heating rollers 330 to form the nip, where the pressing roller 350 could be another heating roller, thereby heating the printed print medium 101 simultaneously on its printed side and its reverse side to increase drying efficiency. According to an example, any combination of rollers may be used in the heat conduction-based drying configuration 320 as long as it contains at least one heating roller 330. The image forming apparatus 10 may further include a mechanical calendaring device to apply pressure to the print medium. For example, the mechanical calendaring device may be a cold calendaring roller. According to an example, heating roller 330 may be combined with the cold calendaring roller to increase performance and/or lower cost.

Allowing the print medium 101 to travel along the transport path P1 through the nip 320N while the ink is still wet may create some risk of damaging the image, but controlling the pressing force and applied heat in the nip 320N, for example, to accommodate different print medium and ink characteristics, may reduce such risk. According to an example, the combined heat and pressure in the nip 320N may promote more efficient drying and substantially improve flattening effects, while reducing or eliminating potential damage to the image for certain ink/print medium types, which is an unexpected result.

As illustrated in FIG. 3, the heat conduction-based drying configuration 320 may include a sensor to detect the surface temperature of the heating roller 330 and a temperature modulator. For example, the heat conduction-based drying configuration 320 may include a thermistor 330T1 as the sensor to sense the surface temperature of the heating roller 330 and may generate an electric signal to indicate the sensed surface temperature and a thermostat 330T2 to cut off the power supply 450 to a heating medium. According to an example, when the surface temperature of the heating roller 330 goes beyond a given threshold value, thermostat 330T2 interrupts electrical power to the heating medium. The thermistor 330T1 detects the surface temperature of the heating roller 330 and transmits the result of the detection to a controller, which will be discussed later.

According to an example, the pressing roller 350 may have rigidity sufficient to apply the pressing force. A contact surface of the pressing roller 350 to contact the print medium may have low surface energy. For example, the contact surface of the pressing roller 350 may have surface energy low enough to reduce or suppress wetting of the contact surface of the pressing roller 350 by the ink. For example, the surface layer of the pressing roller 350 may have surface energy lower than surface energy of the ink. For example, the surface layer of the pressing roller 350 may have surface energy lower than water, alcohol, ink color pigment, or combinations thereof.

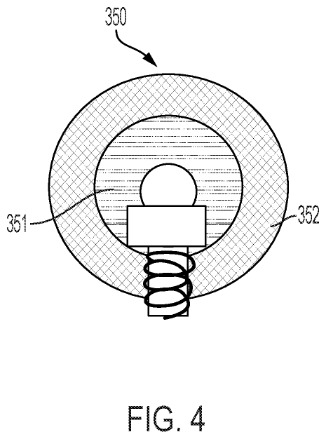

FIG. 4 illustrates an example of the pressing roller 350. Referring to FIG. 4, the pressing roller 350 may include a metal pipe as the rigid core 351 or as the rigid layer 351 and a rubber-based layer formed around the rigid core 351 or the rigid layer 351 as the buffer layer 352.

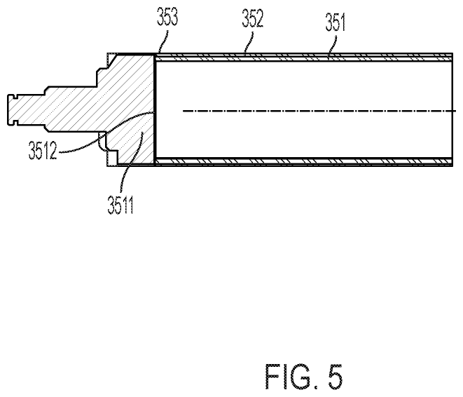

FIG. 5 illustrates a cross-sectional view of the pressing roller 350 according to an example.

Referring to FIGS. 4 and 5, the pressing roller 350 may include a rigid core 351 or a rigid interior layer 351, a buffer layer 352, a coating layer 353 forming the contact surface of the pressing roller 350, or any combination thereof. A variety of materials and dimensions may be implemented for each layer of the roller. For example, the rigid core 351 or the rigid interior layer 351 may include a metal pipe, such as a steel pipe. For example, STKM or SUM 22 may be used as the material for the steel pipe. For example, the buffer layer 352 may be a rubber-based material and may have thickness from about 1 to about 2 millimeter (unit: mm). The coating layer 353 may be implemented to include a perfluoroalkoxy-based polymer (PFA), polytetrafluoroethylene (PTFE), or any other polymer or material with low surface energy such that the surface layer of the heating roller 30 has low surface energy. For example, the coating layer 353 may have surface energy low enough to reduce or suppress wetting of by the ink. For example, the coating layer 353 may have surface energy lower than surface energy of the ink. For example, the coating layer 353 may have surface energy lower than water, alcohol, ink color pigment, or combinations thereof. For example, the coating layer 353 may have a thickness of about 30 μm.

Referring to FIG. 5, the pressing roller 350 may include a metal pipe as the rigid core 351, a rubber based layer formed around the rigid core as the buffer layer 352, and a PFA tube disposed to cover the rubber based layer as the coating layer 353. According to an example, the rigid core 351 may include a shaft part 3511 welded to the metal pipe to provide a shaft connection. For example, the shaft part 3511 may include a welding face 3512 onto which the metal pipe can be welded.

According to an example, the heating roller 330 may have rigidity sufficient to apply the pressing force. The contact surface of the heating roller 330 to contact the print medium 101 may have surface energy low enough to reduce or suppress wetting of the contact surface of the heating roller 330 by the ink. For example, the contact surface of the heating roller 320 may have surface energy lower than surface energy of the ink. For example, the contact surface of the heating roller 330 may have surface energy lower than water, alcohol, ink color pigment, or combinations thereof.

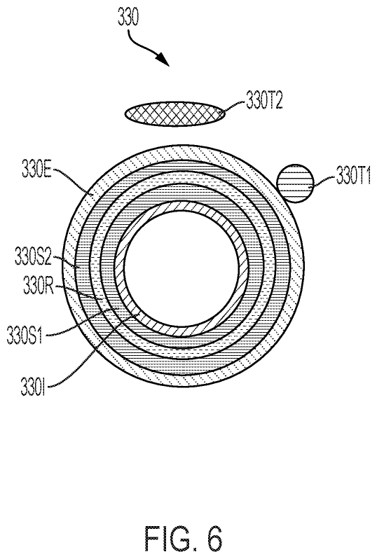

FIG. 6 illustrates a cross-sectional view of the structure of the heating roller 330 according to an example.

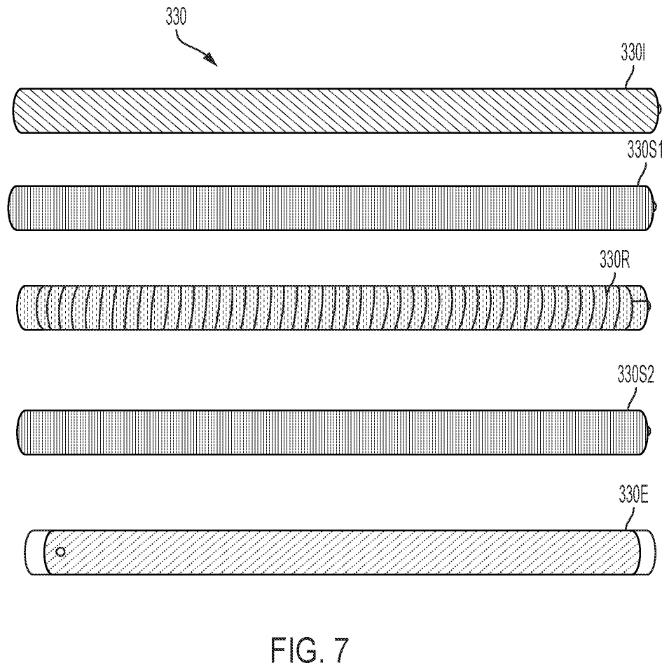

FIG. 7 illustrates the layer structure of the heating roller 330 according to an example.

Referring to FIG. 6 and FIG. 7, a heating roller includes an exterior layer 330E, a heating element 330R as a heating medium 330R, and an interior layer 330I. The heating roller may also include an inner electrical insulation layer 330S1 and an outer electrical insulation layer 330S2 surrounding the heating medium 330R. The inner electrical insulation layer 330S1 and the outer electrical insulation layer 330S2 electrically insulate the heating medium 330R.

The interior layer 330I may be a layer or a core having rigidity sufficient to apply the pressing force. For example, the interior layer may include a metal layer such as an interior metal pipe. Different materials may be implemented as the interior metal pipe. For example, the interior metal pipe may include a copper alloy, aluminum alloy, nickel alloy, iron alloy, chrome alloy, or magnesium alloy. The interior metal pipe according to an example may be made of aluminum or its alloy, or may be made of steel or its alloy, for their heat conductibility. The interior metal pipe may be closely adhere internal structures, for example, the heating medium 330R and the inner and outer electrical insulation layers 330S1 and 330S2, to the exterior layer 330E. The interior metal pipe as the interior layer 330I can help improve the heat transfer efficiency by providing no air gap between the exterior layer 330E, outer electrical insulation layer 330S2 and the heating medium 330R, or by providing no air gap between at least some of the layers, so as to increase heat conductibility of heat from the heating medium 330R to be conducted to the exterior layer 330E and hence to the print medium 101 contacting the exterior layer 330E. Moreover, the interior metal pipe as the interior layer 330I may be expandable toward the exterior layer 330E, so as to prevent at least some of layers from slipping from each other.

In case of transferring heat by heat radiation and/or heat convection, the interior layer having rigidity sufficient to apply the pressing force may hinder or block the heat radiation and/or the heat convection. According to an example, the heat conduction may not be hindered or blocked as much as the heat radiation and/or the heat convection, because the interior layer 330I having sufficient rigidity may be of a material that may conduct heat. According to an example, the heating medium or element 330R may be embedded over the interior layer 330I and between the contact surface of the heating roller 330 and the interior layer 330I, heat can be conducted to the contact surface without having to be conducted through the interior layer 330I.

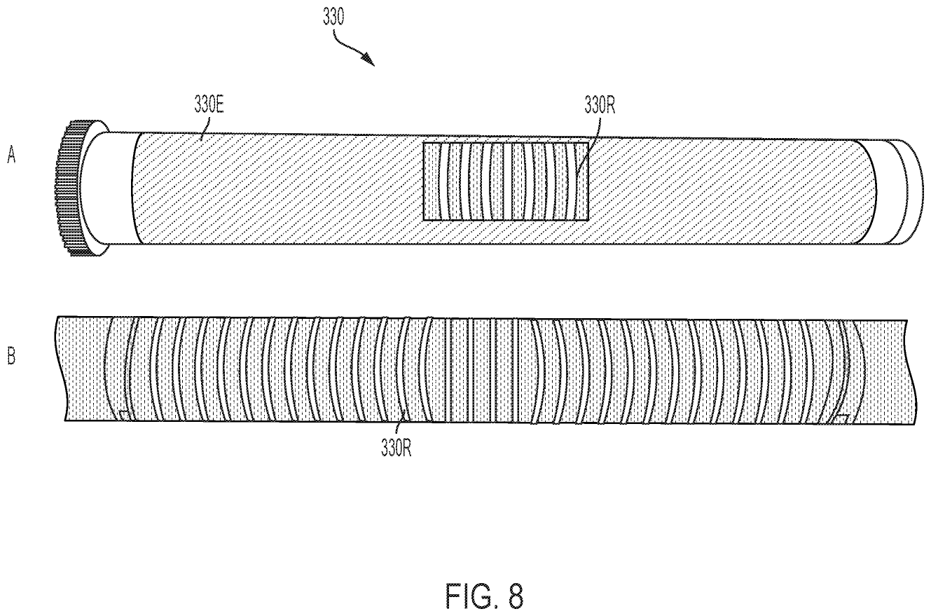

FIG. 8 illustrates an example of the heating medium 330R and the exterior layer 330E. According to an example, a heating medium 330R that is electrically powered heats by conduction the print medium 101 onto which an image is formed by the ink-based image former and may include an electric resistor embedded in the heating roller 330 to generate heat to heat the print medium 101. A variety of suitable electric resistor types may be implemented as the electric resistor. For example, a variety of forms, such as a wire, tape or sheet, and a variety of suitable materials, such as metal-based material, carbon-based compounds, or any combination thereof, may be implemented for the electric resistor. For example, the electric resistor may be a heating coil circumferentially coiled around a center of the heating roller. For example, the electric resistor may be a wire, tape or sheet that is provided so as to be elongated on the heating roller in a direction parallel to an axis of rotation of the heating roller. For example, the heating medium 330R may include at least one layer of the electric resistor. For example, the metal-based material may include a copper alloy, aluminum alloy, nickel alloy, iron alloy, tin alloy, chrome alloy, platinum alloy, tungsten alloy, Molybdenum alloy, Tantalum alloy, or any combination thereof. For example, the carbon-based compounds may include graphite, graphene and carbon nano tubes, or any combination thereof. For example, a variety of suitable materials may include silicon carbide, molybdenum disilicide, Lanthanum (LaCrO3), or Zirconium, or any combination thereof. According to an example, the electric resistor has a suitable resistance value (unit: ohms, Ω) to generate heat to electrically heat the print medium 101. For example, the electric resistor may have a resistance value that is equal to or less than about 100 ohms.

According to an example, the inner electrical insulation layer 330S1 and the outer electrical insulation layer 330S2 may be provided to electrically insulate the heating medium 330R. According to an example, a variety of materials may be implemented to constitute the inner electrical insulation layer 330S1 and the outer electrical insulation layer 330S2. For example, the material for the inner electrical insulation layer 330S1 may include mica-based material, polyimide, ceramic, silicon, polyurethane, glass, and polytetrafluoruethylene (PTFE), or any combination thereof. For example, the material for the outer electrical insulation layer 330S2 may include mica-based material, polyimide, ceramic, silicon, polyurethane, glass, and polytetrafluoruethylene (PTFE), or any combination thereof. For example, a mixture of polyimide and mica may be implemented for the inner electrical insulation layer 330S1 and/or the outer electrical insulation layer 330S2. According to an example, the mica-based material may be a form of a mica sheet. According to an example, the inner electrical insulation layer 330S1 and the outer electrical insulation layer 330S2 may be comprised of polyimide. Polyimide is a polymer that can withstand voltage and is resistant to dielectric breakdown. Polyimide may be made thin to increase heat transferability and efficiency.

According to an example, the exterior layer 330E may include a coating layer. For example, a coating layer may be added to further withstand the wearing of the heating roller and further reduce the contamination by ink. A variety of materials may be implemented for the coating layer, including a perfluoroalkoxy-based polymer (PFA), polytetrafluoroethylene (PTFE), or any other polymer or material with low surface energy. The coating layer of the heating roller 330 may have surface energy low enough to reduce or suppress wetting of by the ink. For example, the coating layer may have surface energy lower than surface energy of the ink. For example, the coating layer may have surface energy lower than water, alcohol, ink color pigment, or combinations thereof. According to an example, the thickness of the coating layer may be about 2.0 mm or less for heat conduction efficiency.

The exterior layer 330E according to an example may include a metal layer. According to an example, a coating layer may be coated around the metal layer, to form an exterior surface of the heating pipe. For example, the metal layer according to an example may be a metal pipe such as an exterior pipe made of aluminum or its alloy, or may be made of steel or its alloy, for its property of heat conductibility. According to an example, the metal layer may be coated with a coating agent. According to an example, the coating layer may formed by a coating agent coating the outer electrical insulation layer 330S2.

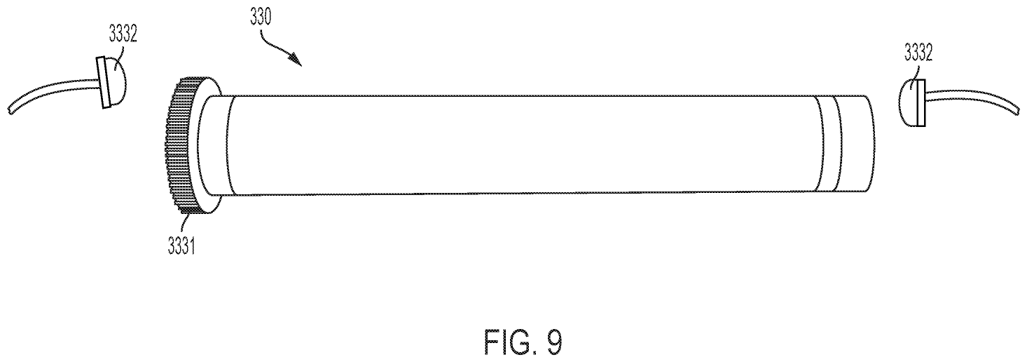

According to an example, the heating medium 330R receives power through a power connection formed on one end or both ends of the heating roller. FIG. 9 illustrates an example of the power connection. Referring to FIG. 9, each power connection may include a rotating portion 3331 and a non-rotating portion 3332. The non-rotating portion 3332 is coupleable to the rotating portion 3331. The shape of the non-rotating portion 3332 may be complimentary to the rotating portion 3331, so as to be couplable to each other. The non-rotating portion 3332 may include a power transmission portion to be connected to a driving device. Electrodes may be respectively installed on the rotating portion 3331 and the non-rotating portion 3332. Current is applied to the electrodes to supply power to the heating medium 330R to generate heat while the heating roller 330 is rotating.

According to an example, the print medium dryer 30 may include another drying configuration 310, in addition to the heat conduction-based drying configuration 320, to further aid the drying process. For example, an additional drying configuration 310 may be disposed between the ink-based image former 20 and before the heat conduction-based drying configuration 320 along the conveying path connecting the ink-based image former 20 and the print medium dryer 30. For example, the additional drying configuration may be a non-contact drying configuration 310 to dry the print medium 101 without contacting the print medium 101. According to an example, the non-contact drying configuration 310 may initiate drying of the print medium 101 before the heat conduction-based drying configuration 320 contacts a surface of the print medium 101, so as to reduce a possible ink transfer from the surface of the print medium 101 to a surface of the heating roller 330 and/or the pressing roller 350, which may degrade the quality of the formed image, may contaminate the print medium 101 with residual ink on the heating roller 330 and may reduce the expected durability of the heating roller 330 and/or the pressing roller 350. According to an example, a variety of devices and/or components may be implemented as the non-contact drying configuration 310. For example, the non-contact drying configuration 310 may employ a heat radiation-based drying mechanism, a heat convection-based drying mechanism, or a combination of both the heat radiation-based and heat convection-based drying mechanism. According to an example, the non-contact drying configuration 310 may dry the print medium 101 by moving air around the print medium 101. For example, the non-contact drying configuration 310 may blow air toward the print medium 101 to dry the print medium 101. According to an example, the non-contact drying configuration 310 may dry the print medium 101 by applying heat to the print medium 101. For example, the non-contact drying configuration 310 may dry the print medium 101 by radiating heat to the print medium and/or deliver heat to the print medium 101 by heat convection by moving air carrying heat around the print medium 101. According to an example, the non-contact drying configuration 310 may dry the print medium 101 by both moving air around the print medium and applying heat to the print medium 101. According to an example, the non-contact drying configuration 310 may dry the print medium 101 based on a parameter including, for example, an amount of the wet ink deposited onto the print medium, a type of the wet ink, a type of the print medium, or any combination thereof.

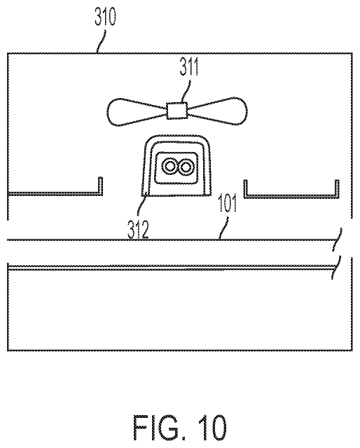

FIG. 10 illustrates an example of the non-contact drying configuration 310. According to an example, the non-contact drying configuration 310 may include an air blower 311 and a heater 312. For example, the air blower 311 may include a blowing fan to move air around the print medium 101. For example, the heater 312 may include a heater that may radiate the heat to the print medium 101, may heat air to be moved around the print medium 101, or may simultaneously radiate the heat to the print medium 101 and heat air to be moved around the print medium 101 to convect heat to the print medium. A variety of devices or components may be implemented for the heater 312. For example, the heater 312 may include an electric resistance-based heater to radiate heat to the print medium 101, heat air around the heater to be moved around the print medium 101, or to simultaneously radiate the heat and heat air around the heater. For example, the heater 312 may include a halogen lamp-based heat radiator. For example, the heater 312 may include a combination of an air moving medium and a heating device. For example, the dryer may include a non-contact drying configuration 310 including a lamp to irradiate a light to an ink on a print medium 101 and a blowing fan to dry an ink on a print medium 101 by blowing air to the print medium 101. According to an example, the non-contact drying configuration 310 may include a plurality of air blowers as the air blower 311 and/or a plurality of heaters as the heater 312, to apply heat and/or move air from different locations. For example, a plurality of heaters, such as lamps, may be provided and plurality of air blowers, such as blowing fans, may be respectively provided on both sides of the conveying path for moving the print medium 101, so that opposite surfaces of a print medium 101 are dried by the plurality of heaters and/or the plurality of blowing fans, respectively. According to an example, When a plurality of images are formed on a single side or both sides of the print medium 101, some or all of the plurality of heaters, some or all of the plurality of air blowers, or any combination thereof, such as all of the plurality of heaters and the plurality of air blowers may be operated, so as to quickly and/or efficiently dry the print medium 101 and/or ink on the print medium 101.

Various parameters, such as parameters for the wait time between printing and drying, the amount of nip pressure, transport speed through the system, and the heating roller temperatures for drying, may be varied to control the non-contact drying configuration 310 and the heat conduction-based drying configuration 320. For example, the parameters may be varied to optimize the drying of the print medium 101 without compromising print quality. The optimum parameters may be different in different printing systems, for differing amounts of ink deposited on the print medium 101, for differing types of ink deposited on the print medium, and/or for different media.

According to an example, a temperature of the heating roller around a contact surface of the heating roller to contact the print medium 101 may be controlled to be between about 80° C. and 180° C. may dry the printed media without damaging image quality. For example, a temperature of the heating roller around a contact surface of the heating roller to contact the print medium 101 may be controlled to be between about 80° C. and 180° C. based on a parameter including, for example, an amount of the wet ink deposited onto the print medium, a type of the wet ink, a type of the print medium, or any combination thereof. For example, the temperature of the heating roller around the contact surface may be controlled to be between about 80° C. and 110° C. For example, the temperature of the heating roller around the contact surface may be controlled to be to about 110° C. For example, the heating roller 330 according to an example may heat up the roller to a target temperature within about 20 seconds.

According to an example, a speed of processes by the ink-based image former 20, the print medium dryer 30 and other components for the ink-based image forming apparatus may be controlled. According to an example, the heating roller 330 may contact the print medium according to a speed of processes. According to an example, the processes may be controlled to have a speed about 2 to about 35 inches per second (unit: ips). For example, the processes may be controlled to have a speed about 2 to about 35 inches per second (unit: ips) based on a parameter including, for example, an amount of the wet ink deposited onto the print medium, a type of the wet ink, a type of the print medium, or any combination thereof. For example, the processes may be controlled to have a speed about 3 to about 19 ips of feed rate. For example, the heating roller 330 may allow increasing the speed to 24.5 ips. For example, the heating roller 330 may allow increasing the speed to 35 ips. According to an example, the temperature of the contact surface of the heating roller may be controlled to be between about 80° C. to 180° C. based on a speed of process and a parameter including, for example, an amount of the wet ink deposited onto the print medium, a type of the wet ink, a type of the print medium, or any combination thereof. For example, the temperature of the contact surface of the heating roller may be controlled be between about 80° C. to about 110° C., to allow a higher speed of the processes, for example, about 19 ips to about 24.5 ips, or about 19 ips to about 32 ips. For example, when the heating roller 330 is placed before the post-processor 90, the post-processor 90 may accelerate the speed of the process to about 35 ips.

According to an example, various controlling methods and control configurations may be implemented to control various parameters. According an example, various parameters may be obtained from a variety of data sources, such as information obtainable through a sensor, information obtainable from database such as a local data base and network database, user-provided information, and information contained in the image forming job. According to an example, the controlling methods may be implemented as processor executable instructions, which may be written on any form of a computer readable medium.

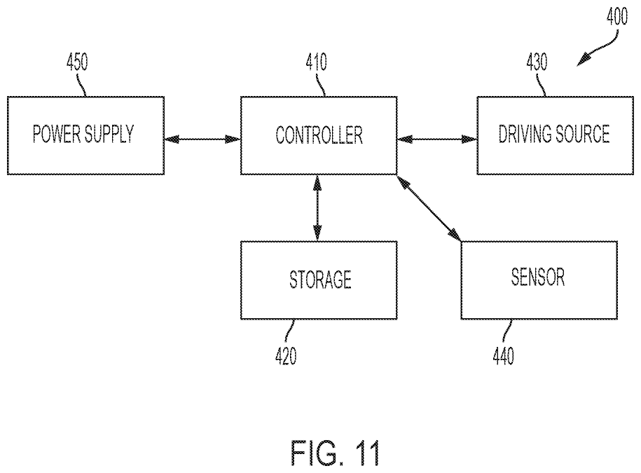

FIG. 11 illustrates a block diagram of a control configuration 400 of controlling the heat conduction-based drying configuration 320 according to an example. The control configuration 400 may be provided in the ink-based image forming apparatus 10. Referring to FIG. 11, the control configuration 400 may include a controller 410 and machine readable storage 420. The control configuration 400 may also include a driving source 430 and a sensor 440 such as thermistor 330T1. The driving source 430 may include a power source, a motor, solenoid, other electromechanical devices, or combinations thereof. The sensor 440 may further include a position sensor that senses a position of the print medium 110 on a path in the heat conduction-based drying configuration 320, a weight sensor, a proximity sensor, a light sensor, or combinations thereof.

According to an example, the controller 410 may monitor and/or control various parameters including the parameters on the wait time between printing and drying, the amount of nip pressure, transport speed through the system, and the heating roller temperatures for drying, to control the non-contact drying configuration 310 and the heat conduction-based drying configuration 320. For example, the controller 410 may control parameters to optimize the drying the print medium 101 without compromising print quality. The optimum parameters may be different in different image forming jobs, for differing types of ink deposited, differing amounts of ink deposited on the print medium 101, and/or for different media. According to an example, the controller 410 may control a temperature of the heating roller around a contact surface of the heating roller to be between 80° C. and 180° C. to dry the printed print medium 101 without affecting image quality. For example, the controller 410 may control the temperature of the heating roller 330 to be between about 80° C. to about 180° C. based on a parameter including, for example, an amount of the wet ink deposited onto the print medium, a type of the wet ink, a type of the print medium, or any combination thereof. For example, the controller 410 may control the temperature of the heating roller 330 to be between about 80° C. to 110° C. For example, the controller 410 may control may control the heating roller 330 to heat up from ambient to a target temperature within about 20 seconds. The target temperature may be controlled to be between 80° C. and 180° C. based on a variety of parameters. According to an example, the controller 410 may control a speed of processes by the ink-based image former 20, the print medium dryer 30 and other components for the ink-based image forming apparatus. According to an example, the controller may control processes for the ink-based image forming apparatus 10 such that the feeding speed of the print medium 101 is from about 2 to about 35 inches per second (unit: ips), for example, from about 3 to about 19 inches per second ips of feed rate. According to an example, the controller may control processes for the ink-based image forming apparatus 10 based on a parameter including, for example, an amount of the wet ink deposited onto the print medium, a type of the wet ink, a type of the print medium, or any combination thereof, such that the feeding speed of the print medium 101 is from about 2 to about 35 inches per second (unit: ips), for example, from about 3 to about 19 inches per second ips of feed rate. According to an example, the heating roller 330 may allow increasing the speed to 24.5 ips. According to an example, the heating roller 330 may allow increasing the speed to 35 ips. Accordingly, the controller 410 may control the processes at a speed about 2 to about 35 ips of feed rate. According to an example, the controller 410 may control the temperature of the heating roller to be between about 80° C. to 180° C., to allow a higher speed of the processes, for example, about 19 ips to 24.5 ips. According to an example, the controller 410 may control a higher speed of the processes, for example, about 35 ips, based on an operation of the post-processor 90.

The controller 410 may execute instructions stored in the machine readable storage 420. The controller 410 may control the power supply 450 to the heating medium 330R according to the detected surface temperature of the heating roller 330 to keep the surface temperature within a given range. The controller 410 may receive temperature information of the heating roller 330 from thermistor 330T1 and may control thermostat 330T2 to cut off the power supply 450 to the heating medium 330R when the temperature information received from the thermistor 330T1 is greater than a predefined threshold.

The control configuration 400 may be connected with at least one other control configuration in a wired and/or wireless manner such that the control configuration 400 and the at least one other control configuration can communicate with one another to exchange information, including a user input information and job information regarding an image forming job performed or to be performed by the ink-based image forming apparatus 10 including performing an image forming job, a scanning job, a finishing job, or any combinations thereof. The at least one other control configuration may be a host device, such as a personal computer, smartphone, tablet, or laptop, for example. The at least one other control configuration may be another device such as a server, image forming apparatus, or post-processor 90, for example.

The controller 410 may include, for example, a processor, an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, or any combinations thereof.

The machine readable storage 420 may be any electronic, magnetic, optical, or other physical storage device that stores executable instructions. For example, the machine readable storage 420 may include a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof.

According to an example, the print medium dryer 30 can dry and flatten the print medium 101 simultaneously. According to an example, the print medium dryer 30 can promote more efficient drying and substantially improve flattening effects, while reducing or eliminating potential damage to the image for certain ink/print medium types. Moreover, because the print medium dryer 30 can transfer heat to the print medium 101 by heat conduction, efficiency of delivering heat to the print medium is substantially improved compared to devices transferring heat by heat radiation and heat convection. Moreover, because the heating medium 330R is implemented within the layers of the heating roller 330, a space between a heat source and a surface of the roller is eliminated, thereby reducing time for heating the roller to a target temperature. The heating roller 330 may heat up the roller to a target temperature in less than about 20 seconds and no more than about 40 seconds, for example. Moreover, implementing the heat conduction-based drying configuration 320 may eliminate the space between a heat source and a surface of the roller and allow a more rigid structure, which is capable of withstanding more pressing force for the flattening effect of the heating roller 330. The more rigid structure of the heating roller also allows longer life-time of the heating roller 330, which necessitates less maintenance.

Although examples of the disclosure have been illustrated and described above, the disclosure is not limited thereto, and may be variously modified without departing from the spirit and scope of the disclosure as claimed in the claims. These modifications are to fall within the scope of the disclosure.

What is claimed are:

1. A heating roller for a wet ink-based image forming apparatus, the heating roller comprising:
a roller having a contact surface to contact a print medium having wet ink deposited thereon by wet ink-based image forming apparatus, to conductively heat the print medium, and to dry and flatten the print medium; and
a heating element, embedded along the roller, to rotate with the roller as the roller rotates, and to generate and conduct heat to the contact surface so as to conductively heat the print medium through the contact surface when the contact surface contacts the print medium.

2. The heating roller of claim 1, wherein the roller is to rotate at a speed based on an amount of the wet ink deposited onto the print medium and/or a type of the print medium.

3. The heating roller of claim 2, wherein the roller is to rotate at the speed between 2 inches per second to 35 inches per second, based on the amount of the wet ink deposited onto the print medium and/or the type of the print medium.

4. The heating roller of claim 1, wherein the heating element is to generate and conduct heat to the contact surface of the roller based on an amount of the wet ink deposited onto the print medium and/or a type of the print medium.

5. The heating roller of claim 4, wherein the heating element is to generate and conduct heat to the contact surface of the roller to a temperature between 80° C. and 180° C., based on the amount of the wet ink deposited onto the print medium and/or the type of the print medium.

6. The heating roller of claim 1, wherein
the roller includes at least one of a rigid layer or a rigid core, and
the at least one of the rigid layer or the rigid core is to apply a pressing force to the print medium via the contact surface of the roller.

7. The heating roller of claim 1, wherein the contact surface of the roller has a surface energy to suppress wetting.

8. The heating roller of claim 1, wherein the roller includes:
an interior layer including at least one of a rigid layer or a rigid core,
an inner electrical insulation layer disposed between the interior layer and the heating element, to electrically insulate the heating element, and
an outer electrical insulation layer disposed on the heating element and over the inner electrical insulation layer, to electrically insulate the heating element.

9. The heating roller of claim 1, wherein the roller includes a heat conduction portion to conduct heat to the contact surface, the heat conduction portion having no air gap inbetween the heating element and the contact surface, to conduct heat generated by the heating element to the contact surface.

10. A wet ink-based image forming apparatus, comprising:
a wet ink-based image former to deposit wet ink onto a print medium and to form an image on the print medium;
a heating device to dry and flatten the print medium having the wet ink deposited onto the print medium, the heating device including:
a first roller having a contact surface to contact the print medium having the wet ink deposited, to conductively heat the print medium, and to dry and flatten the print medium, and
a heating element, embedded along the first roller, to rotate with the first roller as the first roller rotates, and to generate and conduct heat to the contact surface so as to conductively heat the print medium through the contact surface when the contact surface contacts the print medium; and
a second roller, rotatable with the first roller, to apply a pressing force to the first roller.

11. The wet ink-based image forming apparatus of claim 10, wherein the first roller is to rotate at a speed between 2 inches per second to 35 inches per second, based on an amount of the wet ink deposited onto the print medium and/or a type of the print medium.

12. The wet ink-based image forming apparatus of claim 10, wherein the heating element is to generate and conduct heat to the contact surface of the first roller to a temperature between 80° C. and 180° C., based on an amount of the wet ink deposited onto the print medium and/or a type of the print medium.

13. The wet ink-based image forming apparatus of claim 10, wherein
the first roller and the second roller are to apply a pressing force to the print medium contacting the contact surface of the first roller, and
the first roller and the second roller each include at least one of a rigid layer or a rigid core to apply the pressing force.

14. The wet ink-based image forming apparatus of claim 10, wherein the contact surface of the first roller has a surface energy to suppress wetting.

15. A non-transitory machine-readable storage medium comprising instructions executable by at least one processor, the non-transitory machine-readable storage medium comprising:
instructions to control a rotation speed of a roller having a contact surface to contact a print medium having wet ink deposited thereon by a wet ink-based image forming apparatus, the rotation speed being 2 inches per second to 35 inches per second, based on an amount of the wet ink deposited onto the print medium and/or a type of the print medium; and
instructions to control a temperature of the contact surface of the roller to between 80° C. and 180° C. based on the amount of the wet ink deposited onto the print medium and/or the type of the print medium, by supplying power to a heating element embedded along the roller and rotating with the roller as the roller rotates, so as to conductively heat the print medium through the contact surface when the contact surface contacts the print medium.
